(19) United States
(12) Patent Application Publication
(10) Pub. No.: US 2021/0216996 A1
(43) Pub. Date: Jul. 15, 2021

(54) DEVICE AND METHOD FOR SECURING SECURE DATA FOR A BANK PAYMENT CARD

(71) Applicant: CCS 12, Marseille (FR)

(72) Inventors: Charli ABISDID, Marseille (FR); Marlene ABISDID, Marseille (FR)

(21) Appl. No.: 16/967,526

(22) PCT Filed: Aug. 7, 2019
(86) PCT No.: PCT/FR19/51912

§ 371 Date: Aug. 5, 2020

(30) Foreign Application Priority Data
Dec. 11, 2018 (FR) 1872665

(51) Int. Cl. G06Q 20/32; G06Q 40/02; G06Q 20/34; G06K 19/10; G06K 19/06; G06K 7/14; G06Q 20/40; G06T 11/00

(52) U.S. Cl. CPC G06Q 20/3276; G06Q 40/02; G06Q 20/3558; G06K 19/10; G06K 19/06159; G06Q 2220/00; G06K 7/1417; G06Q 20/3274; G06Q 20/4014; G06Q 20/4018; G06T 11/00; G06K 7/1491

(57) ABSTRACT

The method secures data of a bank card linked to a bank account. The data is static and includes the number of the card, the identification data of the holder of the card, the expiration date of the card, and a cryptogram. The bank card number and cryptogram include multiple digits and/or letters. The method includes inscribing only partially secure data on the card in such a manner that the data is concealed and never visible on the card. The concealed data is multiple digits and/or letters of the number of the card and/or at least an identification datum of the holder and/or at least one element of the expiration date and/or at least one digit and/or letter of the cryptogram. The method includes transmitting to the only cardholder a means for disclosing the concealed data.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The object of the invention relates to a device and a method for securing security data of a bank payment card.

The present invention pertains to the field of securing data generally written on a face of a bank payment card in order to secure the payment transactions.

### 2. Description of Related Art Including Information Disclosed Under 37 CFR 1.97 and 37 CFR 1.98

The security data linked to a bank account is affixed on a payment card, such as the card number, the client's name and the expiration date, which generally appear in an embossed manner, on the front (or front side) of said card. The security code or visual cryptogram is affixed to the back (or rear side) of the card. The user must typically provide this security information when executing a transaction online or over the telephone.

This payment mode is currently very widespread. However, despite the efforts of banks, online stores and other companies specializing in the security of bank cards, fraud by means of online or telephone hacking or simply by the physical theft of the card and the telephone of this security data is also increasing. To a lesser degree, the visual hacking of security data, for example when making a direct payment to a retailer is also being done. This may be the case when paying for a purchase in a store where the sales assistant copies security data unbeknownst to the cardholder. Hackers can then execute transactions remotely on their own behalf by using this security data to the detriment of the cardholder, or resell this data to a third party.

Certain devices have been developed to attempt to better secure bank card data.

For example, patent documents FR3051581 or US 2014/0279555 propose solutions in which the cryptogram is no longer a static datum printed on the card, but a dynamic datum generated by the card at the time of confirming a banking transaction. However, this type of card is expensive and particularly complex to produce. In addition, in the event the card is stolen, the cryptogram, even if generated dynamically, will be visible to the thief at the time a fraudulent bank transaction is confirmed. The changing cryptogram protects data stored by online stores. In the event of hacking, this solution is thus solely relevant to phishing situations that consist of a hacker stealing data stored by the online retailer.

Patent document FR3051060 discloses a cryptogram security method. Multiple cryptograms are printed on the card, issued and recognized by the bank. These cryptograms must be used in a predefined sequence. A manually movable mark in relation to the cryptograms allows the cardholder, according to a personal procedure, to store the position of the cryptogram that he will have to use for the next transaction. Although this solution may be interesting in some respects, it does have disadvantages. In fact, if the card is stolen, the thief will know all of the cryptograms. Given that there is a limited number of them, one only has to “test” several cryptograms in succession to validate a fraudulent bank transaction.

Document US 2010/243741 discloses a securing method according to the preamble of the main claim. The hidden data is inscribed on a medium that is separate from the card. By combining this medium with the card, the user can retrieve all the security data. Document U.S. Pat. No. 5,326,964 discloses a similar process. This type of process is relatively limited in terms of security.

One object of the invention is to remedy the disadvantages of prior art. Another object of the invention is to propose a solution allowing one to better secure security data of a payment card and to make it unusable in the event of theft.

### BRIEF SUMMARY OF THE INVENTION

The solution proposed by the invention is a process for securing security data of a bank payment card linked to a bank account, which security data is static and comprises the number of said card, the identification information of the holder of said card, the expiration date of said card, and a cryptogram, which bank card number and which cryptogram are composed of multiple digits and/or letters.

This method comprises the steps consisting of:
inscribing only partially the security data on said card in such a manner that the security data is concealed, which hidden data is formed by: multiple digits and/or letters of the number of said card and/or at least one identification datum of the holder and/or at least one element of the expiration date and/or at least one digit and/or letter of the cryptogram,
transmitting to the only cardholder a means of disclosing the concealed data.

The method also comprises the following steps:
hiding the concealed data among multiple pieces of data,
arranging the data in a grid,
visibly inscribing the grid on one face of the card,
transmitting to the only cardholder a revealing pattern of the concealed data, which revealing pattern:
   appears in the physical form of a mask having a form that is complementary to the grid and comprising a series of transparent or latticed windows allowing only concealed data to appear when said mask interacts with the grid, except for said windows, the remainder of said mask being opaque, or
   appears in the physical form of a transparent medium having a form that is complementary to the grid and comprising graphic elements, which graphic elements are arranged and configured to emphasize the concealed data when said carrier is superimposed on the grid, or
   appears in the virtual form of an augmented reality image generated by an app installed in a mobile terminal of the cardholder, which image of the revealing pattern is posted on a screen of said terminal by superimposing itself on a real image of the grid also posted on said screen.

The security data is now only partially inscribed—in a readable manner—on the bank payment card. Also, if the card were to be stolen, the thief will never be able to use it since it is impossible for him to know all of the security data. Only the cardholder knows the security data. The invention thereby aims to create a security lock, particularly prior to any online transactions. In fact, to execute a purchase online, it is necessary to provide certain security data that only the cardholder will be able to provide. If the card is stolen, the arrangement of the data in the grid makes the number of combinations to be “tested” for validating a fraudulent bank transaction very much higher than the solutions known from prior art (approximately 10,000 times higher). Thus, the invention greatly secures the payment cards so as to make them unusable when picked up fraudulently by ill-intentioned individuals.

Other advantageous features of the invention are listed below. Each of these features may be considered alone or in combination with the noteworthy features defined above, and if applicable may be the subject matter of one or more divisional patent applications:

According to one embodiment, the method comprises a step consisting of generating the augmented reality image of the revealing pattern in the form of an image of a mask whose form is complementary to the real image of the grid and comprising a series of windows revealing only the real image of the concealed data when the image of said mask is superimposed on the image of said grid.

According to one embodiment, the augmented reality image of the revealing pattern is generated in the form of an image emphasizing the real image of the concealed data when said augmented reality image is superimposed on the image of the grid.

Advantageously, the card number is composed of four series of four digits, the method comprising a step involving the concealment of the second and/or third series.

The method may comprise a step that involves placing the concealed data in the grid in a random or logical manner.

Another aspect of the invention relates to a securing device for the security data of a bank payment card linked to a bank account, which security data is static and comprises the number of said card, identification data of the holder of said card, the expiration date of said card, and a cryptogram, which bank card number and which cryptogram are composed of several digits and/or letters.

The device also comprises the following features:
the security data is only partially inscribed on the card in such a manner that the security data is concealed, which concealed data being formed by: multiple digits and/or letters of the number of said card and/or at least an identification datum of the holder and/or at least one element of the expiration date and/or at least one digit and/or letter of the cryptogram,
the device comprises a means for disclosing the concealed data.
the concealed data is hidden among several pieces of data arranged in a grid, which grid is visibly inscribed on a face of the card,
the device comprises a revealing pattern of the concealed data, said revealing pattern:
   appearing in the physical form of a mask having a form complementary the grid and comprising a series of transparent or latticed windows revealing only concealed data when said mask interacts with the grid, except said windows, the remainder of said mask being opaque, or
   appearing in the physical form of a transparent medium having a form complementary to the grid and comprising graphic elements, which graphic elements are arranged and configured for emphasizing the concealed data when said medium is superimposed on the grid, or
   appearing in the virtual form of an augmented reality image generated by an app installed in a mobile terminal of the cardholder, which image of the revealing pattern is posted on a screen of said terminal by superimposing itself on a real image of the grid also posted on said screen.

According to one embodiment, the augmented reality image of the revealing pattern is in the form of an image of a mask whose form is complementary to the real image of the grid and comprising a series of windows revealing only the real image of the concealed data when the image of said mask is superimposed on the image of said grid.

According to one embodiment, the augmented reality image of the revealing pattern is in the form of an image emphasizing the real image of the concealed data when said augmented reality image is superimposed on the image of the grid.

According to one embodiment, the grid comprises multiple boxes each containing a digit between 0 and 9, each digit being represented one or more times in said grid.

### BRIEF DESCRIPTION OF THE SEVERAL VIEWS OF THE DRAWINGS

Other advantages and features of the invention will be clarified upon reading the description of a preferred embodiment below, with reference to the attached drawings produced as non-limiting, illustrative examples.

FIG. 1a is a front elevation view (front side) of a card according to the invention, according to an embodiment not covered by the claims.

FIG. 1b is a rear elevation view (back side) of the card from FIG. 1a.

FIG. 2a is a front elevation view of a card according to the invention, based on another embodiment not covered by the claims.

FIG. 2b is a rear elevation view of the card from FIG. 2a.

FIG. 3a is a front elevation view of a card according to the invention, based on another embodiment not covered by the claims.

FIG. 3b is a rear elevation view of the card from FIG. 3a.

FIG. 4a is a front elevation view of a card according to the invention, based on another embodiment not covered by the claims.

FIG. 4b is a rear view of the card from FIG. 4a.

FIG. 5a is a front elevation view of a card according to the invention, based on another embodiment covered by the claims.

FIG. 5b is a schematic view of a diagram of a mask used for revealing the concealed data in the card from FIG. 5a.

FIG. 5c is a schematic view depicting the card from FIG. 5a combined with the mask from FIG. 5b.

FIG. 5d is a schematic view of a diagram of another type of revealing pattern used for revealing the concealed data in the card from FIG. 5a.

FIG. 5e is a schematic view depicting the card from FIG. 5a combined with the revealing pattern from FIG. 5d.

FIG. 6a is a front elevation view of a mobile terminal used for implementing the method according to another embodiment covered by the claims.

FIG. 6b is a front elevation view of a diagram of a real image of a bank payment card posted on a screen of a mobile terminal from FIG. 6a.

FIG. 6c is a front elevation view of a diagram of a virtual image of a revealing pattern posted on the screen of the mobile terminal from FIG. 6b, which virtual image is superimposed on the real image of the grid also posted on said screen.

FIG. 6d is a front elevation view of a diagram of another virtual image of a revealing pattern posted on the screen of the mobile terminal from FIG. 6b, which virtual image is superimposed on the real image of the grid also posted on said screen.

### DETAILED DESCRIPTION OF THE INVENTION

The attached drawings depict a payment card 1, or bank card (CB). The card 1 is linked to a bank account of its holder. It typically comes in the form of a plastic card measuring approximately 86 mm×54 mm. It is equipped with an electronic chip 2 having flush contacts on the front side, and possibly a magnetic strip 3 on the back side. The chip 2 and/or the strip 3 allows the payment to be made to brick-and-mortar stores having an electronic payment terminal or to online stores. It also allows cash withdrawals from automatic teller machines (ATMs).

The card 1 is linked to security data. This security data is static in the sense that it is permanent and does not change over time. In a known manner, the security data comprises the number 4 of the card 1, identification data 5 of the holder of said card, the expiration date 6 of said card, and a cryptogram 7. The number 4, the identification data 5 and the expiration date 6 are typically inscribed on the front side of the card 1, while the cryptogram 7 is inscribed on the back side of said card. The number 4 is composed of multiple series of digits, for example four series of four digits, or 16 digits total. The number 4 may also be composed of multiple digits, not arranged in series, of an alphanumeric code (combination of digits and letters) or a series of letters. The identification data 5 typically comprises the last name and first name of the cardholder, or the name of a company holding the bank account linked to the card 1. The date 6 is composed of two elements, typically the expiration month in two digits (e.g., 02 for February) and the expiration year in two digits (e.g., 25 for 2025). Obviously, the month and/or the year may be composed of more or less digits and may be linked to letters. The cryptogram 7 is composed of multiple digits, typically three digits (e.g., 432), but it may also be composed of more digits (for example, four digits) or fewer ones (for example, two digits). The cryptogram 7 may also be composed of digit(s) and/or letter(s).

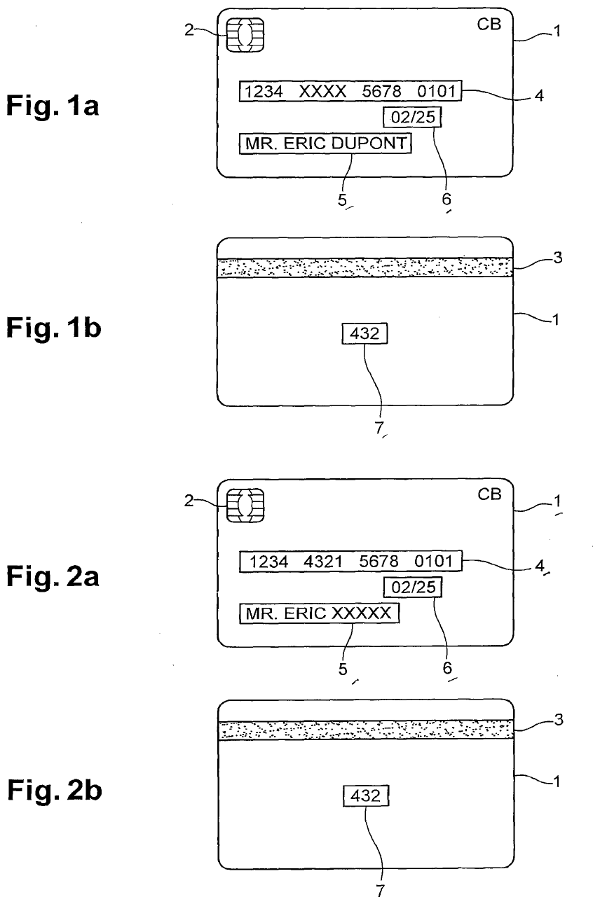

In FIGS. 1a and 1b, one secures the security data by only partially inscribing the number 4 on the card 1. At least one series of digits is concealed here in such a manner that it is never visible on the card 1. One preferably conceals the second and/or third series to the extent that the first series may be common to multiple payment cards and the fourth series generally appears on the cash register receipt. All the series may also be concealed. The concealed digits (and/or letters) may be replaced by X's (XXXX), dots, dashes, and so on. The second and the third series may be concealed at the same time. One can also consider concealing a number in each series in such a manner that none of the series is fully inscribed on the card 1.

In FIGS. 2a and 2b, one secures the security data by inscribing only partially the user name 5 of the holder on the card 1. The name of the holder (DUPONT) is concealed here in such a manner that only the first name (ERIC) is visible on the card 1. One can also conceal the first name in such a manner that it is never visible, with only the last name being inscribed. One can also conceal the last name and first name of the holder. The concealed data may be replaced by X's (XXXX), dots, dashes and so on. It is advantageous to have the ability to identify the holder of the card 1, even though the last name and/or the first name are concealed. To do so, the number of the holder's identity card or passport may be inscribed on the card 1. A merchant wanting to ensure that the card 1 truly belongs to its holder can then ask the latter for his identity card or passport.

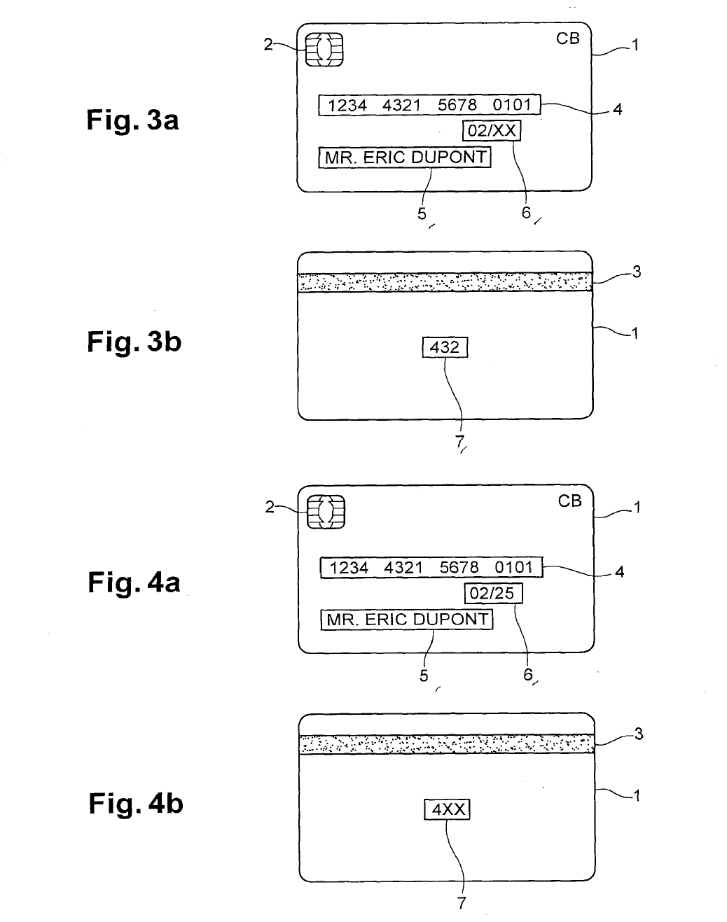

In FIGS. 3a and 3b, one secures the security data by inscribing only partially the expiration date 6 on the card 1. Here, the year is concealed in such a manner that it is never visible. Only the month is inscribed. One can also conceal the month in such a manner that it is never visible, with only the year being inscribed. One can also conceal the month and the year of the expiration. The concealed data may be replaced by X's (XXXX), dots, dashes and so on.

In FIGS. 4a and 4b, one secures the security data by inscribing only partially the cryptogram 7 on the card 1. At least one digit (and/or letter), advantageously two digits (and/or letters) and preferably all the digits (and/or letters) of the cryptogram are concealed. The concealed digits (and/or letters) may be replaced by X's (XXXX), dots, dashes and so on.

The embodiments described above may be combined in that one can simultaneously conceal all or part of the number 4 and all or part of the cryptogram 7. One can also conceal all or part of the number 4 and all or part of the expiration date 6. All the possible combinations are covered by the present invention.

In the rest of the description, the concealed elements of the security data are referred to as “concealed data.” The security data of the card 1 may be recorded on the chip 2 and/or in the magnetic strip 3. To prevent any hacking, it is preferably provided that the concealed data of the chip 2 and/or the magnetic strip 3 is/are eliminated.

A means of disclosing this concealed data is communicated to the only cardholder. This disclosure means may consist of a document sent by postal mail to the holder of the card 1 and on which is printed the concealed data. To secure the communication of the concealed data, this document may be a sealed document, sent in a separate letter or attached to the letter sent along with the card 1. It may even be the same document on which the secret code of the card 1 is printed (generally a four-digit code), allowing one to withdraw money from cashpoints and to pay merchants. The holder will thus be able to memorize or record this concealed data, which will be known to him alone.

To withdraw money from cashpoints and to pay merchants, the holder will conventionally use the secret code of card 1. For online purchases, he only has to fill in the security data required by the concealed data. Therefore, if the holder has his card 1 stolen, the thief will not be able to sue it for fraudulent purchases made online or over the telephone, since he will never know the concealed data. The level of security conferred by the invention is such that it may replace SMS-OTP authentication generally used to secure online payments. The SMS-OTP authentication process is widespread and consists of sending to the holder's mobile telephone a text message (short message service (SMS)) that includes a one-time password (OTP). This one-time password must be provided in addition to security data to validate an online transaction.

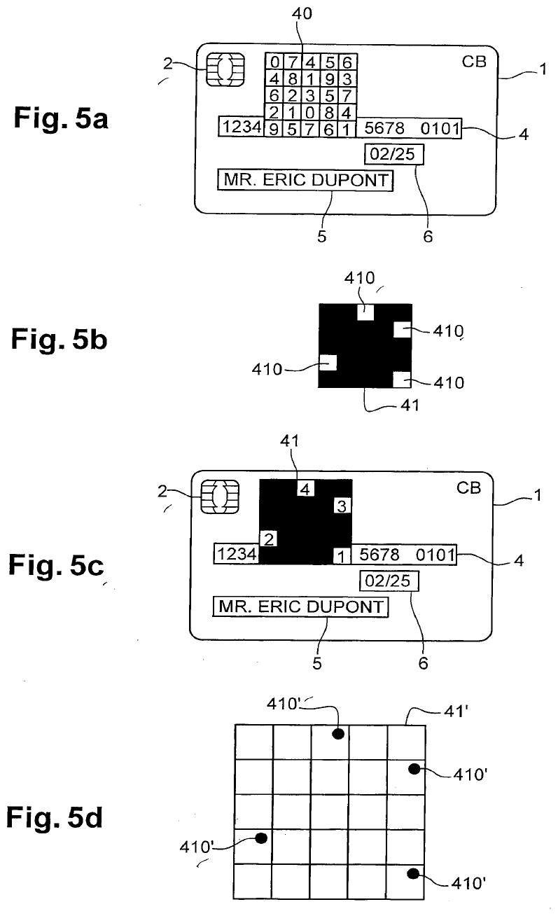

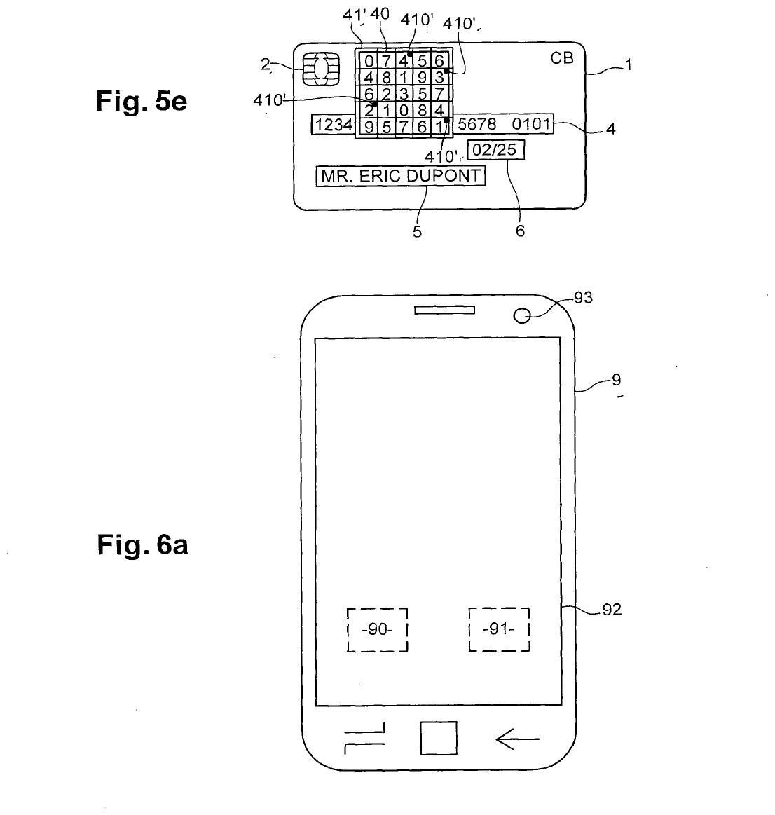

FIGS. 5a, 5b and 5c illustrate an embodiment of the invention covered by the claims. In FIG. 5a, the concealed data corresponds to the second series of digits of the number 4. The concealed digits are visible but hidden among several digits arranged in a grid 40. The grid 40 is preferably printed or inscribed in a visible manner on the front face of the card 1, in the area of the number 4 to simplify use. However, it may also be printed on the back.

In FIG. 5a, the grid 40 comprises 25 boxes each containing a digit between 0 and 9. The grid 40 may have a larger number of boxes, for example 100 boxes each containing a digit between 0 and 9, each digit being represented 10 times. The grid 40 may also have a smaller number of boxes, for example 10 boxes each containing a digit between 0 and 9, each digit being represented one single time. The digits may be arranged randomly in the grid 40, or otherwise arranged in a logical manner. The grid 40 is preferably composed of lines and columns. The number of lines is comprised between 0 and 10, and the number of columns is also comprised between 0 and 10. The grid 40 may also be composed of one or several checkered concentric circles in which the digits are arranged. Obviously, if the concealed data of the number 4 comprises letters, these letters may be included in the grid 40.

Referring to FIG. 5b, the holder is provided with a revealing pattern that allows the concealed data to be revealed, in other words the missing digits of the number 4, in the grid 40. This revealing pattern appears in the physical form of a mask 41 having a form that is complementary to the grid 40 and comprises a series of transparent or latticed windows 410. Except for the windows 410, the remainder of the mask is opaque. The mask 41 may be delivered in a sealed document, sent in a separate letter, or attached to the one with which the card 1 was sent.

Referring to FIG. 5c, when the mask 41 is positioned over the grid 40 or in other words, when it interacts with said grid, the windows 410 reveal the concealed digits of the number 4. The mask-grid combination is similar to the Cardan grid cryptography method. In the example shown, the series 4321 is revealed, which series corresponds to the initially concealed data. The holder can then memorize or record this concealed data, which will be known to him alone. If he does not remember the concealed data, the holder can also reuse the mask 41 to make them reappear.

In a variant of the design from FIG. 5d, the revealing pattern appears in the physical form of a transparent medium 41′ having a form that is complementary to the grid 40. This transparent medium 41′ is for example constructed of plastic. It comprises graphic elements 410′ arranged and configured to emphasize the concealed data when said medium is superimposed on the grid 40. In FIG. 5d, these graphic elements 410′ appear in the form of dots positioned on the surface of the medium 41′. Referring to FIG. 5e, when medium 41′ is placed over the grid 40, the dots are positioned in the squares of said grid in which the concealed data of the number 4 is positioned. Therefore, the graphic elements 410′ allow only the concealed data to be revealed.

The graphic elements 410′ do not necessarily appear in the form of dots but may appear in another form, for example in the form of a series of circles surrounding the digits 4-3-2-1 of the concealed series when the medium 41′ interacts with the grid 41.

The medium 41′ may be provided with a mark indicating the side to be positioned against the grid 40. Similarly, in FIG. 5d, the medium 41′ optionally comprises a grid similar to the grid 40 to simplify positioning said medium on said grid by matching up said grids.

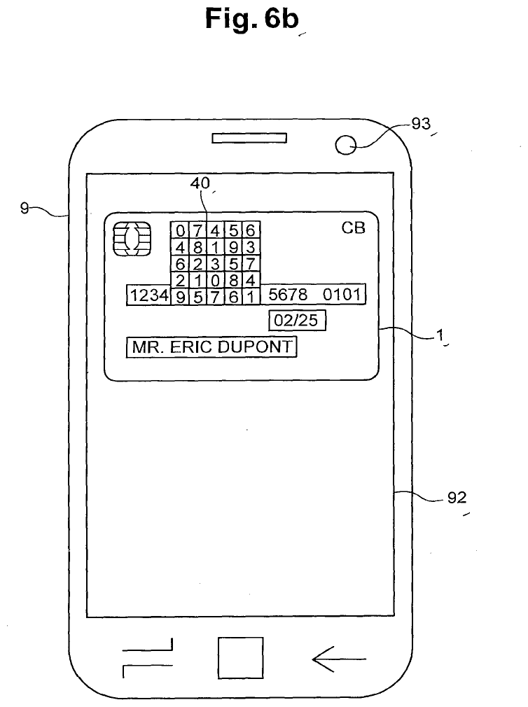

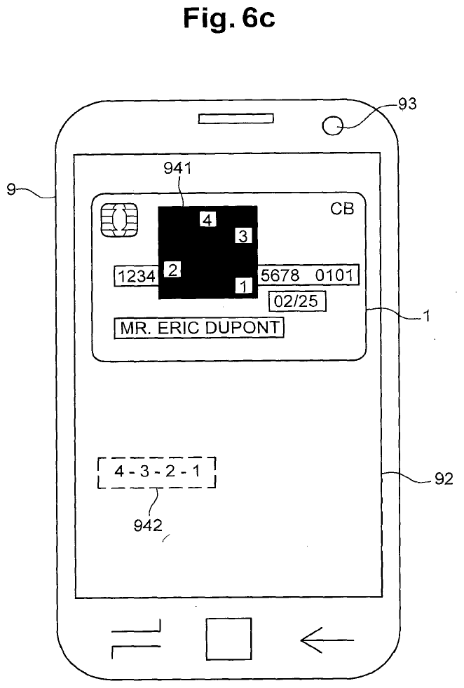

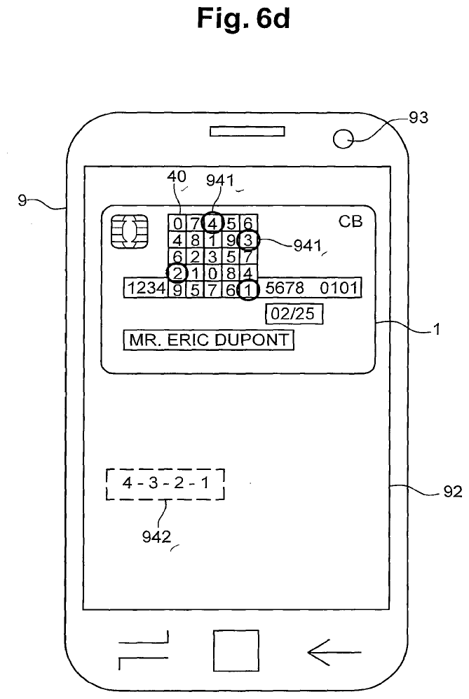

FIGS. 6a, 6b, 6c and 6d depict another embodiment of the invention covered by the claims. The concealed data corresponds to the second series of digits of the number 4. The concealed digits are visible but hidden among multiple digits arranged in a grid 40 as in the embodiment of FIGS. 5a to 5c.

Implementation of the method according to this embodiment makes use of a mobile terminal 9 (FIG. 6a) appearing preferably in the form of a mobile telephone or iPhone®-, Samsung Galaxy®-type smartphone, or in the form of another electronic terminal, operating with a Windows, Mac, iOS, Android or other type of operating system. The mobile terminal 9 is that of the holder (user) of the card 1.

The mobile terminal 9 comprises in particular, in a conventional manner, one or more processors or microprocessors 90, one or more memories 91, a graphic interface 92 and a visual acquisition means 93, which are interconnected via a common bus. One or more apps—or computer programs—are stored in the memory/memories 91, whose instructions (or codes), when executed by the processor(s) 90, allow the functions described earlier in the description to be executed.

The security data of the card 1, and at least the concealed data, are preferably prestored in the memory 90. If the user has several bank cards, the security data of each card, and at least their concealed data, are prestored in the memory 90. It shall be noted that the memory 91 may be a native memory of the terminal 9 or a remote memory, for example incorporated in a remote physical computer server.

The graphic interface 92 gives users the ability to capture, select and/or input data or instructions, and to post images acquired from the optical acquisition means 93. It appears for example in the form of a touch screen or a screen connected to a keyboard, and so on.

The optical acquisition means 93 appears preferably in the form of an optical scanner, of the video camera and/or photo camera types, incorporated in the mobile terminal 9. This optical acquisition means 93 is linked to a scanning app.

The user may have to install an app in his mobile terminal 9 to implement all or part of the invention from said terminal and in particular the posting of augmented reality images. This app may be preinstalled on the terminal 9. However, the user can look for this app on an online store such as Google Play®, iTunes® or on a dedicated website, and then download it to his terminal 9.

For the sake of clarity, it shall be understood within the meaning of the invention that “the terminal 9 does something” means “the app executed by the processor or microprocessor 90 of the terminal 9 does something,” just like “the app does something” means “the app executed by the processor or microprocessor 90 of the terminal 9 does something.”

Referring to FIG. 6b, the user opens his scanning app from his mobile terminal 9 and captures all or part of the image of the card 1 with the optical acquisition means 93. The real image of the card 1 is then posted on the graphic interface 92 of the terminal 9.

By means of a visual recognition app, such as Google Lens®, the terminal 9 recognizes that the photographed object is a bank card and that this card comprises the grid 40.

Based on optical character recognition (OCR), the terminal 9 will analyze the image of the grid 40 and in particular the digits arranged in it.

The terminal 9 will look for the concealed data (e.g., the series 4321) in the memory 91 and look for this data (e.g., each of the figures 4-3-2-1) in the image of the grid 40.

The terminal 9 will then generate an augmented reality image of the revealing pattern and post this virtual image on the screen 92 by superimposing it on the real image of the grid 40.

In FIG. 6c, the augmented reality image of the revealing pattern appears in the form of an image of a mask 941 whose form complements the real image of the grid 40. Here, the image of the mask 941 comprises a series of windows revealing only the real image of the concealed data when the image of said mask is superimposed on the image of said grid. In the example in FIG. 6c, the series 4321 is revealed by the virtual image of the mask 941, which series corresponds to the initially concealed data.

In FIG. 6d, the augmented reality image of the revealing pattern appears in the form of an image 941 emphasizing the real image of the concealed data when said augmented reality image is superimposed on the image of the grid 40. Here, this virtual image is a series of circles surrounding the image of the digits 4-3-2-1 of the concealed series. However, these digits may be emphasized in another manner, for example by highlighting, or by enlarging, or by blurring the other digits inscribed in the grid 40 and so on.

In any event, the generated virtual image may include concealed data that is posted in a dedicated graphic region 942.

The grid and mask system described with reference to FIGS. 5a, 5b, 5c, 6b, 6c, 6d applies similarly to identification data 5 (last name and/or first name of the cardholder, in which the grid 40 comprises a series of letters), the expiration date 6 and/or the cryptogram 7 and/or the number of the identification card or passport of the holder, and so on, if the concealed data is part of these elements.

In the embodiments described above, the arrangement of the various elements and/or means and/or steps of the invention shall not be understood as requiring such an arrangement in all implementations. In particular, one or more features shown only in one embodiment may be combined with one or more other features shown only in another embodiment.

1. A method for securing security data of a bank payment card linked to a bank account, which security data is static and comprises the number of said card, identification data of the holder of said card, the expiration date of said card, and a cryptogram, which bank card number and which cryptogram are comprised of multiple digits and/or letters, said method comprising the steps of:
inscribing only partially the security data on said card in such a manner that the security data is concealed, which concealed data is formed by: multiple digits and/or letters of the number of said card and/or at least one identification datum of the holder and/or at least one element of the expiration date and/or at least one digit and/or letter of the cryptogram,
transmitting to the only holder of the card a disclosure means for the concealed data,
hiding the concealed data among several pieces of data,
arranging the data in a grid,
visibly inscribing the grid on the face of the card, and
forwarding to the only holder of the card a revealing pattern of the concealed data,
wherein said revealing pattern appears as one of a group consisting of:
a physical form of a mask having a form that is complementary to the grid and comprising a series of transparent or latticed windows revealing only the concealed data when said mask interacts with the grid, except for said windows, the remainder of said mask being opaque,
a physical form of a transparent medium having a form that is complementary to the grid and comprising graphic elements, which graphic elements are arranged and configured to emphasize the concealed data when said medium is superimposed on the grid, and
a virtual form of an augmented reality image generated from an app installed in a mobile terminal of the holder of the card, which image of the revealing pattern is posted on a screen of said terminal by superimposing itself on a real image of the grid also posted on said screen.

2. The method according to claim 1, further comprising the step of: generating an augmented reality image of the revealing pattern in the form of an image of a mask whose form is complementary to the real image of the grid and comprising a series of windows revealing only the real image of the concealed data when the image of said mask is superimposed on the image of said grid.

3. The method according to claim 1, further comprising the step of: generating the augmented reality image of the revealing pattern in the form of an image emphasizing the real image of the concealed data when said augmented reality image is superimposed on the image of the grid.

4. The method according to claim 1, wherein the number of the card is comprised of four series of four digits, the method comprising a step of concealing the second and/or third series.

5. The method according to claim 1, the method further comprising a step of: placing the concealed data in random order on the grid.

6. The method according to claim 1, the method further comprising a step of: placing the concealed data in a logical order on the grid.

7. A device for securing security data of a bank payment card linked to a bank account, which security data is static and comprises the number of said card, the identification data of the holder of said card, the expiration date of said card, and a cryptogram, which bank card number and which cryptogram are comprised of multiple digits and/or letters,
wherein the security data is inscribed only partially on the card in such a manner that the security data is concealed, which concealed data is comprised of: multiple digits and/or letters of the number of said card and/or at least one identification datum of the holder and/or at least one element of the expiration date and/or at least one digit and/or letter of the cryptogram, the device comprising:
a disclosure means for the concealed data,
wherein the concealed data is hidden among several pieces of data arranged in a grid, which grid is visibly inscribed on a face of the card; and
a revealing pattern of the concealed data,
wherein said revealing pattern is comprised of one of a group consisting of:
a physical form of a mask having a form that is complementary to the grid and comprising a series of transparent or latticed windows revealing only the concealed data when said mask interacts with the grid, except for said windows, the remainder of said mask being opaque,
a physical form of a transparent medium having a form that is complementary to the grid and comprising graphic elements, which graphic elements are arranged and configured to emphasize the concealed data when said medium is superimposed on the grid, and
a virtual form of an augmented reality image generated by an app installed in a mobile terminal of the holder of the card, which image of the revealing pattern is posted on a screen of said terminal by superimposing itself on a real image of the grid also posted on said screen.

8. The device according to claim 7, wherein the augmented reality image of the revealing pattern appears in the form of an image of a mask whose form is complementary to the real image of the grid and comprising a series of windows revealing only the real image of the concealed data when the image of said mask is superimposed on the image of said grid.

9. The device according to claim 7, wherein the augmented reality image of the revealing pattern appears in the form of an image emphasizing the real image of the concealed data when said augmented reality image is superimposed on the image of the grid.

10. The device according to claim 7, wherein the grid comprises several boxes each containing a digit between 0 and 9.

11. The device according to claim 10, wherein each digit is represented several times in the grid.

12. The device according to claim 10, wherein each digit is represented once in the grid.

13. The device according to claim 7, wherein the concealed data belongs to a number of the identification card or passport of the holder of the card inscribed on said card.
